(19) United States
(12) Patent Application Publication
(10) Pub. No.: US 2004/0242283 A1
(43) Pub. Date: Dec. 2, 2004

(54) Teleclock

(76) Inventor: Edwin S. Flores, Dallas, TX (US)

Correspondence Address: CHALKER FLORES, LLP, 12700 PARK CENTRAL, STE. 455, DALLAS, TX, 75251, US

(21) Appl. No.: 10/817,746

(22) Filed: Apr. 2, 2004

Related U.S. Application Data
(60) Provisional application No. 60/460,660, filed on Apr. 7, 2003.

(51) Int. Cl. H04M 1/00

(52) U.S. Cl. 455/566

(57) ABSTRACT

A method, apparatus and system for providing a user with a single unit that includes a clock and a telephone is disclosed that includes a telephone having a first and a second surface and a clock display, e.g., a digital clock face, that is at least about forty, fifty, sixty or higher percent of either the first or second surface of the telephone at that is visible from, e.g., at least about fifteen feet to a person with ordinary vision.

### FIELD OF THE INVENTION

The invention relates to a telephone clock combination, and more particularly, to a teleclock that combines a telephone and a clock in a single-unit.

### BACKGROUND OF THE INVENTION

Without limiting the scope of the invention, its background is described in connection with clock base stations that have a telephone disposed on the base station, as an example.

Heretofore, in this field, a number of utility and design patents have issued that include, in combination, a base station that may or may not include a clock and a telephone handset that sets on the base station that may be, e.g., a portable telephone. Alternatively, the user may purchase a separate telephone or a clock. Finally, the user may purchase a telephone that contains a small display that may be used to, e.g., provide caller-identification.

Examples of patents for telephone include a patent abstract of Japan No. A-06 120 881, which describes a cordless telephone having a base station and a handset that include each a clock circuit. The clock of the base station is controlled by a clock generation circuit in the telephone switch that connects the base station to the telephone line.

Yet another example is U.S. Pat. No. 6,363,256, issued to Muller, et al., for a cordless telephone system that includes a base station having a base clock indicative of the time of day, and a handset having an internal clock indicative of the time of day. The handset is synchronized to the base station and when power is lost in the handset or the base station, the unit with power detects loss of synchronization. Upon restoration of the power, the continually powered unit provides the power restored unit with clock recovery information for updating the clock of the power restored unit. The clock recovery information is generated in the continually powered unit by counting elapsed time when the loss of synchronization is detected.

An example of a design patent is U.S. Pat. No. D366,873, issued to Nakayama for a cordless telephone combined with clock and radio. This patent claims the ornamental design for a cordless telephone combined with clock and radio and is typical of the prior art design patents.

### SUMMARY OF THE INVENTION

The present invention will find particular uses for individuals that are looking to reduce the number of appliances and space used by separate a clock and telephone. Users of the teleclock will benefit from having a single source for communications and time information and decrease space usage, e.g., in dorm rooms, small apartments, efficiencies, guest rooms, kitchens, manufactured housing, small offices, booths and the like. The present invention relates to a telephone that includes a display that covers at least about forty, fifty, sixty or higher percent of either a first or a second surface of the telephone. The telephone may also include a base station that may provide power to the telephone and may also contain a transmitter, e.g., a wireless transmitter for the telephone.

More particularly, the present invention is an apparatus that includes a telephone having a first and a second surface and a display that covers at least about forty, fifty, sixty or higher percent of either the first or second surface of the telephone. The apparatus may further include a base station that includes a telephone signal transmitter and receiver (or transceiver). The display may include a clock, e.g., a digital or analog clock that is, e.g., an LED display, a liquid crystal display, a plasma display or even a pressure-sensitive liquid crystal display, which may or may not be backlit and all known and future equivalents. Alternatively, the teleclock may even display the time by projecting it on a surface, e.g., when an alarm is triggered. The telephone handset may further include a radio, an alarm, caller-ID and/or an answering machine. If the telephone is a cellular, portable or wireless telephone, the telephone signal may be a radio frequency signal or even an infrared signal.

In one embodiment of the present invention the telephone (e.g., the telephone keypad, microphone and speaker) and the display may be on opposite surfaces. In another embodiment, the display may dim or brighten when, e.g., the telephone rings. In one embodiment the keypad brightens and the clock dims when the telephone rings so that the user may find more readily the ringing telephone. In another embodiment, the display dims and the telephone brightens when the telephone is removed from the base station. The telephone may be powered by a rechargeable power source and may even be a cellular telephone. Alternatively, the apparatus may be powered by a photocell or other power source, as will be known to current and future skilled artisans.

In yet another embodiment, the display and the keypad are both on a liquid crystal display that is substantially the entire first surface of the telephone. In this embodiment, the clock display is generally lit, however, the clock may be replaced by a keypad numeral display, e.g., when a user desires or when the telephone rings. The user may even program different sounds by, e.g., connecting via the telephone to a source of different rings or may even want to change the font, shape, color, intensity or even the size of the display (e.g., an LCD display). The display may even be a color display.

In yet another embodiment of the present invention the telephone/clock includes a handset with a first and a second surface, a keypad, a speaker and a microphone; and a display that cover at least about forty, fifty, sixty or higher percent of either the first or second surface of the telephone. Yet another embodiment of the present invention is a system for providing a clock and a telephone in a single-unit that includes a handset having a first and a second surface, a keypad, a speaker and a microphone and a display that covers at least sixty percent of either the first or second surface of the telephone, wherein the display is visible to a person with ordinary vision from at least about fifteen, twenty, twenty-five, thirty, forty, fifty or even sixty feet. The handset and the display may be backlit, light emitting, pressure sensitive liquid crystal or even touch sensitive. In another embodiment of the system, the keypad and the display are light emitting alternatively. The handset may include further a leg that permits the handset to be self-standing. The keypad and the display may each be powered by an independent power source. The display may be modified for those that are visually challenged. The present invention may also be used as a speakerphone, e.g., on a table or wall-mounted and may even include a remote control to activate the display, telephone or other functions of the teleclock.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 shows an example of a teleclock according to the invention;

FIG. 2 shows another example of a teleclock according to the invention with an analog-like display;

FIG. 3 shows a front and back view of the same handset of yet another embodiment of the present invention;

FIGS. 4A and 4B show one example of the operation of a handset according to the invention;

FIGS. 5A and 5B show another example of the operation of a handset according to the invention in which most of the surface of the handset is a liquid crystal display;

FIG. 6 shows another embodiment of the handset that also includes a radio;

FIG. 7 shows two wall hanging embodiments of the present invention;

FIG. 8 shows yet another embodiment of the present invention with an analog clock and a phone dial speakerphone; and

FIG. 9 shows yet another embodiment of a teleclock of the present invention in which the keypad is around an analog clock face.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention and do not delimit the scope of the invention.

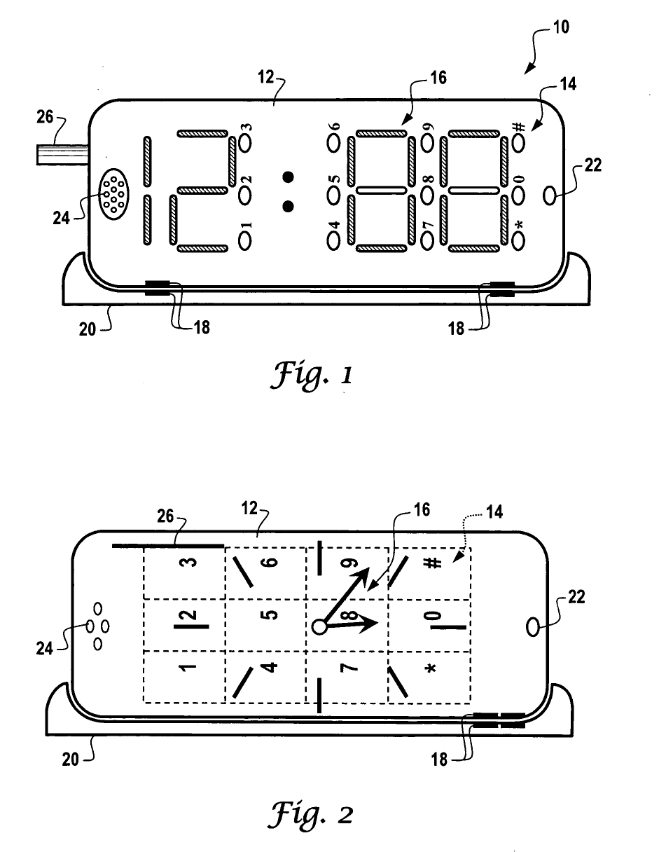

The general features of the teleclock of the present invention are shown in FIG. 1. A teleclock 10 is depicted having a handset 12 that includes a keypad 14. The handset 12 and the keypad 14 form a functional telephone, which may be portable or hardwired. In the embodiment of FIG. 1 the keypad 14 is depicted as small pads with the numerals adjacent the pads. The size of the pads may be adjusted so that they are more or less visible. The shape of the pads of the keypad 14 may be circular, oval, square, or any other shape. The pads of the keypad 14 could also have the numbers printed thereon and may be hard or soft to the touch. Alternatively, the pads may be backlit and the numerals may be viewable at all times or when the handset 12 is removed from the base station 20 or when the user desires. The handset 12 includes a microphone 22, speaker 24, numeric key pad 14 and display 16.

The handset 12 also has disposed thereon a display 16 that covers at least about 40 to 50, 50 to 60, 60 to 70, 80 to 90 and/or 90 to 100 percent of the surface of the handset. The display 16 is depicted in FIG. 1 as a digital display that may be an LED, a liquid crystal or other display. Also disposed on the handset 12 are a microphone 22 and a speaker 24. In the embodiment depicted the handset 12 has an antenna 26. Electrical contact pads 18 are depicted on the base station 20 and the handset 12 that permit for electrical charging of, e.g., a rechargeable power source, an RFID source or power sources that power both the display and the telephone. In one embodiment, one power source supplies power to the display and a separate power source powers the telephone and/or the keypad, e.g., if backlit.

The base station 20 may be a transceiver that is connected to a power supply and a telephone or other communication line. A typical telephone line is one that connects to a plain-old telephone system (POTS) line, a digital subscriber line (DSL), a fiber-optic line, network connections (WAN, LAN, etc.), voice-over-IP (VoIP), however, the present invention is not limited to such systems. The base station 20 may further include, e.g., an antenna, a radio, an internal clock that updates the time displayed on the handset, a modem, hooks or slots for attachment to a wall (for a hanging display). The base station 20 may provide a power supply for a power supply that is integral to the handset, e.g., one or more rechargeable batteries. Alternatively, the handset 12 may self powered by, e.g., independent batteries, independent and rechargeable batteries and/or a photovoltaic cell(s) or combinations thereof.

The display 16 may be, e.g., a light emitting diodes (LED), a liquid crystal display (including but not limited to, backlit, non-backlit, color, pressure sensitive, and the like), a CRT, incandescent bulbs, a micromirror array, a laser, one or more fluorescent bulbs, neon, e-paper, a plasma screen and the like. The skilled artisan will recognize that the power requirements of the different types of display systems will limit the intensity, duration, power requirements and size of the display 16. The display 16 will generally be viewable to a person of ordinary visibility from at least about 10, 15, 20, 30, 45 or even 60 feet. The size, shape, color and intensity of the display may be varied for those that have special viewing challenges or needs. One example of users with special needs are individuals that are color-blind, vision-impaired, elderly or that need a larger display to be able to view the information at either short or long distances.

Regular users as well as individuals with special needs will benefit from the portability of the clock as well as the availability of a telephone nearby. When using a color display, e.g., a backlit, color display the user may even select the color scheme of the display and/or keys of the keypad 14. The display 16 in either a clock or telephone, both clock and telephone or even other information (e.g., date, caller ID, minutes used, battery strength, signal strength) that may be displayed, including dimming and brightening may even be activated via voice recognition or other sound. The handset 12 may also include detection by activating a handset detection signal from the base station or even a remote control so that the user may find the unit away from its base. For example, the display may be monochrome or multi-colored. In one example, the user can select or program the color palette or design of the display, the size of the clock, intensity of the display, type of clock (e.g., from an analog to a digital look), the size and shape of buttons (e.g., from a modern to a traditional keypad or even a rotary look) or even provide a special image, color, tone, display when the phone rings. The teleclock may even be customized to provide different displays and/or colors or images depending on the caller ID of the person calling, e.g., red for telemarketers and green for family, in which case all users, and in particular users with small children, may teach and allow their young children to answer or ignore certain calls. The user may even be able to download tones, colors, palettes, display packages, templates, alarm information (e.g., from a personal digital assistant, computer email or personal calendar or a free or pay service) to remind the user of, e.g., anniversaries, dates, birthdays, meetings, travel, etc. Other types of information that the user of the teleclock may display and/or download includes weather maps and information, e.g., weather alerts, or even reset the time of the clock upon a loss of power.

The telephone may be a portable or a wireless telephone, which are well known to those skilled in the art. In one such system, radio frequency (RF) signals are used to communicate with the handset 12 and even the displays to change the information displayed. Each handset and base station is provided with an RF transmitter and receiver to communicate with the controller. RF transceivers with lesser or greater range may be selected depending on the cost to range ratio, that is, more economical models may require less sophisticated transmitter and receiver pairs. The present invention may even use of multiple RF receivers. In some countries, the use of RF bands is controlled by government regulations, as will be known to those of skill in the art. As such, RF systems may need to be customized for each country to meet its regulations.

Another type of system uses an infra-red (IR) communication system to control display modules. Each display module may self powered by, e.g., batteries, rechargeable batteries and/or a photovoltaic cell and is provided with an IR transmitter and receiver. A system that is able to use photovoltaic power (sometimes called “solar power”) may be used with IR systems because these require less power to operate than RF systems. The photovoltaic charging system may be a portion of the base station 20 and/or the handset 12, and may be used with either an RF or an IR system. The IR transmitter in each display module, however, must be relatively weak to reduce power consumption, and thus the controller must have an IR receiver placed within short range and preferably within line of sight of each display module. Even so, the display module must also limit its transmissions to restrict its power consumption.

The system of the present invention may use an IR system to communicate between, e.g., the base station 20 and the handset 12. IR systems use less power than an RF system. For example, a large solar cell may be used to charge a power source within the handset 12 and the power may be used to power the display 16, the keypad 14 or both. The power source may even power a small window that provides other information, e.g., caller ID, channel, date and the like. A smaller or larger photoelectric module may be used depending on the power needs of the teleclock 10. The location of an IR emitter will depend on the strength of the signal needed to communicate with the handset. In general, a single transmission spectrum will be used per device (i.e., RF or IR) to communicate in both directions with the display modules, although combinations may also be used with the present invention. The telephone may even be used in a motor vehicle when used in conjunction with cellular phone technology, whether analog and/or digital.

Most transceivers capable of transmitting 3-watt signals tend to be heavier and bulkier than the handset. Thus, maximum power transceivers are oftentimes fixed underneath a car seat or installed in the trunk of an automobile, and connected by a coaxial RF power cable to an antenna mounted externally on the automobile. For such transceivers, the handset is also connected to the transceiver by a multi-conductor cable, allowing the handset to be located within easy reach of the driver. Usually, both ends of the cable used to interconnect the handset to the transceiver are provided with multiple pin plugs to facilitate installation of the radio telephone, and to permit the handset to be unplugged and stowed out of sight when the vehicle is unoccupied.

The present invention uses telephone technology known in the art, e.g., the microphone 22 and speaker 24 contained in the handset 24 of a cellular telephone may perform the same functions as the corresponding elements of a conventional telephone handset 12. Thus, the microphone 22 converts sound signals such as speech into electrical signals, which are then coupled to the transceiver and used to modulate a radio frequency carrier signal conveyed to the antenna. Also, modulated radio frequency signals received by the antenna are demodulated within the transceiver, and conveyed to the handset 12 speaker 24 where they are converted into intelligible sounds.

The keypad 14 in the handset 12 is used to punch-out or dial-out numbers, to answer calls, turn system power on and off, and to select operating modes of the system. The numbers dialed and function modes may be displayed on the handset the same handset display 16 (e.g., in a liquid crystal display that changes from clock to telephone) or even on a separate display. The handset 12 may also have other buttons, switches or controls that permit the user to customize the settings of the teleclock 10.

In addition to the portable telephones described above that are intended for relatively permanent or long-term installation using, e.g., a base station 20 in a home or office, another type of radio telephone referred to as a transportable radio telephone or cellular phone may be used. Cellular telephones contain internal batteries that permit the units to be powered away from its power supply. Typically, the RF power output of transportable cellular telephones lies in the range of, e.g., about 0.6, 1.2 watts to 3 watts, however, there is no limitation to the level of power that may be used to connect to a network of cells as long as the power source of the telephone is able to power the transmission and receiving parameters of an antenna. The level of power required, be it from, e.g., a battery, a wire, a photocell or combinations thereof, required to operate the cellular telephones will be determined by the power consumption of the unit, as will be known to those of skill in the art.

The range of hand-held radio or cellular telephones is usually a function of the power source, the level of automation and power range of the antenna of the receiver or transceiver that communicates with the telephone and the cost to manufacture, among other things, that the skilled artisan will appreciate in light of the present disclosure.

FIG. 2 shows another example of a telephone according to the invention with an analog-like display 16. In this embodiment, an analog display is also the keypad 14. In one example, the display 16 may be a thin, at least partially transparent (e.g., a variably transparent, e.g., a laminated or passivated e-paper) film or cover that is overlaid on the keypad 14. The keys 15 of the keypad 14 may be transparent keys that permit the user to see the analog clock face. Controls (not depicted) may be provided on, about or within the handset 12 to control and adjust the analog clock. In this embodiment the electrical pads 18 are positioned adjacent to each other. The actual positioning of the electrical contact pads 18 on the handset 12 and the base 20 may be determined by the skilled artisan depending on design, ergonomic, artistic and/or other constraints, requirements, specifications, desires, etc. In this figure, the antenna 26 is depicted as being on or about the surface of the handset 12.

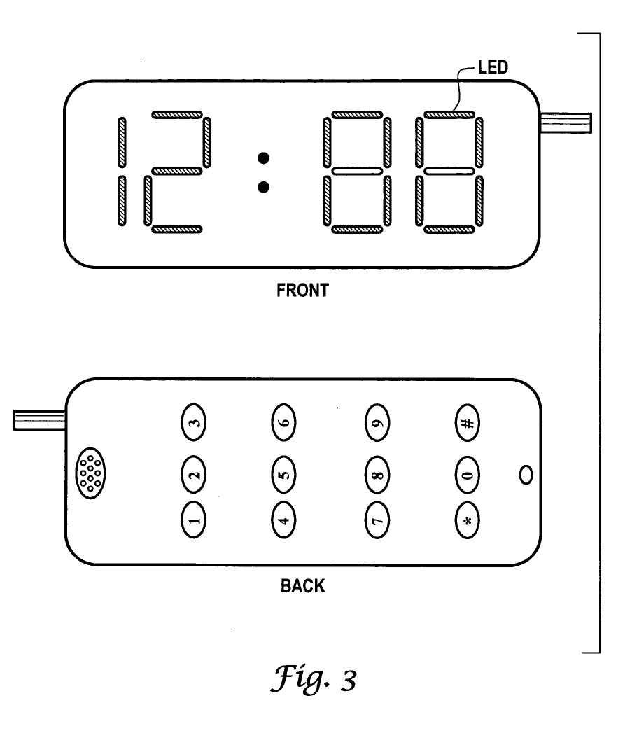

FIG. 3 shows a front and back view of the same handset 12 of yet another embodiment of the present invention. In the handset 12, the clock display 16 is positioned on one surface of the handset 12 and the keypad 14, microphone 22 and speaker 24 are on another surface of the handset. While the handset in the figures is depicted as having two major surfaces, more that two surfaces may be used and implemented as part of the present invention.

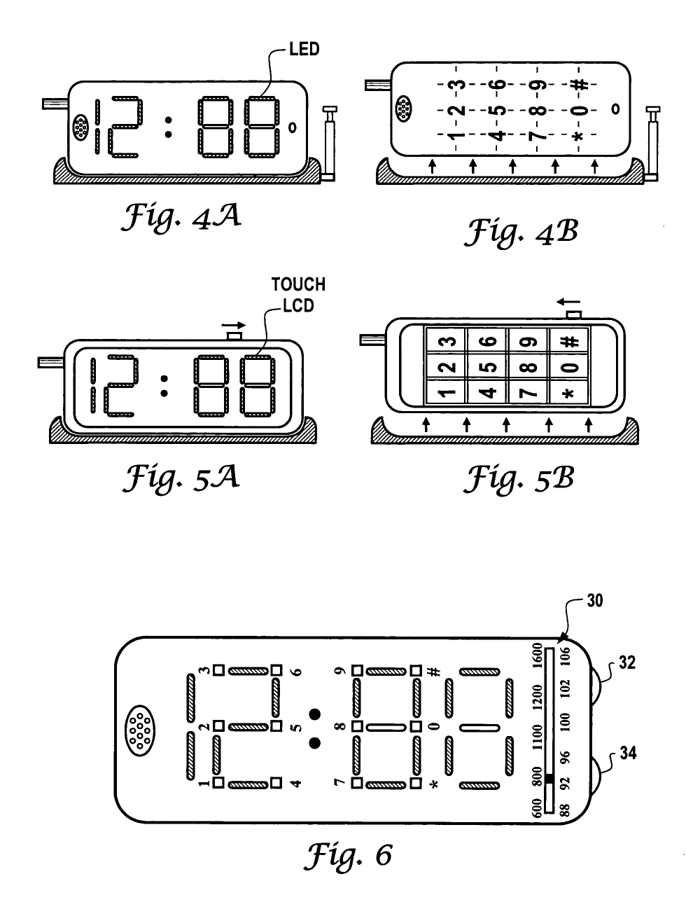

FIGS. 4A and 4B show one example of the operation of a handset according to the invention in which the clock is displayed on display 16 while the handset 12 is on the base station 20 (FIG. 4A), however, when the user lifts the handset 12 from the base station (FIG. 4B) the clock dims or turns off and the numbers of the keypad 14 are lit. This may be accomplished by, e.g., changing the opacity of a thin-film display. The user may be permitted to control the intensity and the function displayed. For example, the user may decide that they need a portable clock while also expecting a telephone call. As such, the user may decide to have on the clock function while awaiting the call, however, either when the telephone rings and/or when the user activates the keypad function, the telephone key pad 14 appears. For example, the user may want the telephone function displayed at all times rather than the clock function, e.g., when in an emergency or other threatening situation.

FIGS. 5A and 5B show another example of the operation of a handset according to the invention in which most of a surface of a handset is a liquid crystal display, as with the example depicted in FIGS. 4A and 4B, the display may change from a clock to the keypad upon a certain event, whether programmed or upon user input. The liquid crystal display 16 may cover most or all the surface of the handset 12 and may be backlit, color, etc.

FIG. 6 shows another embodiment of the handset that also includes a radio 30, with radio controls 32, 34, which may be the tuning and volume, respectively. A radio handset 12 may even include an alarm function that permits the user to have a phone, a clock and a clock-radio alarm in a single unit, which may be, e.g., a portable unit.

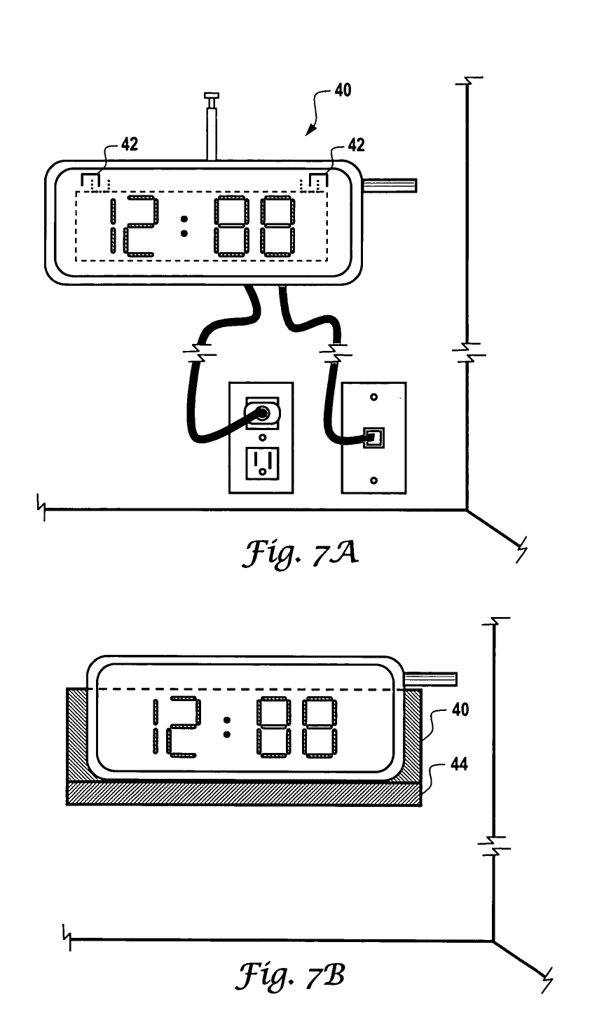

FIGS. 7A and 7B show two wall hanging embodiments of the present invention in which the teleclock 10 may be hanging directly from a wall-mounted, base station 40 that has hooks that match the back of the handset 12 (FIG. 7A). Alternatively, the handset 12 may rest on a lip or support 44 of the wall-mounted, base station 40.

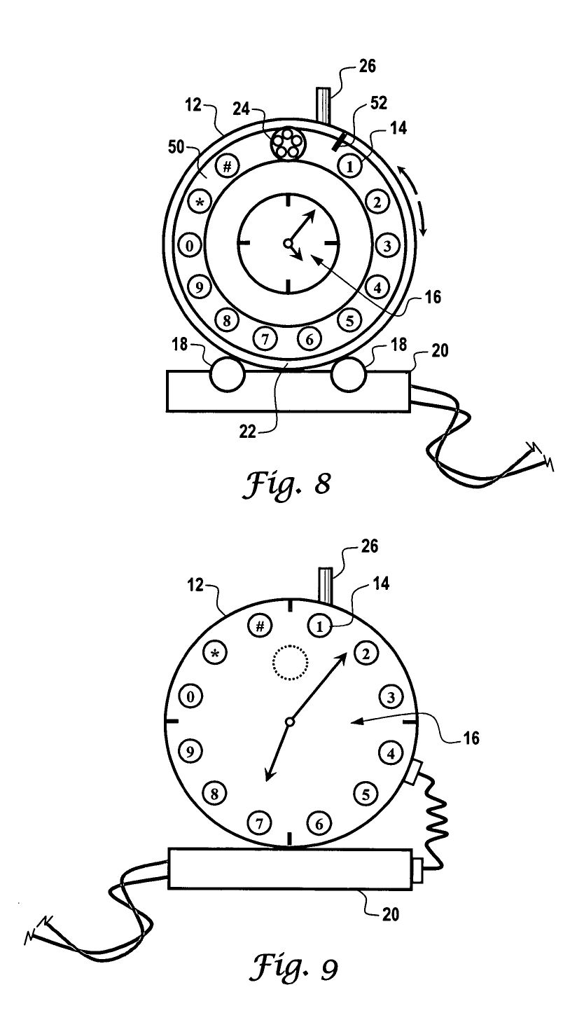

FIGS. 8 and 9 show alternative embodiments of the present invention with an analog clock display 16 and a telephone. In FIG. 8, the analog clock display 14 is surrounded by an analog phone dial 50 that rotates when the user places a finger in the opening for the number to be dialed and rotates the entire dial to a finger hook 52. In FIG. 9 the teleclock 10 uses a digital keypad 14 that is positioned around an analog clock face display 14. In both FIG. 8 and FIG. 9, the telephone has a microphone 22, a speaker 26 and an antenna 26. The embodiments of FIG. 8 and FIG. 9 may also be used as a speakerphone, i.e., the teleclock 10 may be placed on a conference room table, in the kitchen or any room to provide a speakerphone. Extra speakers and/or microphones may be attached to the teleclock 10 to improve reception and transmission of speech. The teleclock 10 may even be placed on a wall and used as a speakerphone.

To provide further hands-off capabilities, the teleclock 10 may be outfitted with a remote control (not depicted) that permits the user to, e.g., change the display, activate the telephone, change settings (e.g., the time, date, intensity, display, radio station, volumes, etc.) or even dial the telephone from the remote. The remore may even have a user-configurable and programmable keypad. The user may also use the remote control to change the time or other functions of the teleclock 10 whether in speakerphone version or not.

Although the present invention and its advantages have been described in detail, it should be understood that various changes, substitutions and alterations can be made herein without departing from the spirit and scope of the invention as defined by the appended claims.

What is claimed is:

1. A apparatus comprising:
a telephone comprising a first and a second surface; and
a clock display that comprises at least fifty percent of the first or second surface of the telephone.

2. The apparatus of claim 1, further comprising a base station that comprises a telephone signal transmitter.

3. The apparatus of claim 1, wherein the display comprises a digital clock, an LED display, a liquid crystal display, a monochrome display, a multi-colored display or a pressure-sensitive liquid crystal display.

4. The apparatus of claim 1, wherein the telephone further comprises a radio or an alarm.

5. The apparatus of claim 2, wherein the telephone signal transmitter is a radio frequency signal transmitter or an infrared signal transmitter.

6. The apparatus of claim 1, wherein the telephone is cordless.

7. The apparatus of claim 1, wherein the telephone and the display are on opposite surfaces.

8. The apparatus of claim 1, wherein the display dims when the telephone rings.

9. The apparatus of claim 2, wherein the display dims and the telephone brightens when the telephone is removed from the base station.

10. The apparatus of claim 1, wherein the telephone is powered by a rechargeable power source.

11. The apparatus of claim 1, wherein the telephone comprises a cellular telephone.

12. The apparatus of claim 1, wherein the apparatus is powered by a photocell.

13. The apparatus of claim 1, wherein the display and the keypad are on a liquid crystal display that is substantially the entire first surface of the telephone.

14. The apparatus of claim 1, wherein the display is a color display.

15. A teleclock comprising:
a handset comprising a first and a second surface, a keypad, a speaker and a microphone; and
a clock display that comprises at least about sixty percent of the first or second surface of the telephone.

16. A system for providing a clock and a telephone in a single-unit comprising:
a handset comprising a first and a second surface, a keypad, a speaker and a microphone; and
a display that comprises at least sixty percent of either the first or second surface of the telephone, wherein the display is visible to a person with ordinary vision from at least about fifteen feet.

17. The system of claim 16, wherein the handset and the display are backlit, light emitting, touch sensitive or a pressure sensitive liquid crystal, a mono-chrome or multi-color display.

18. The system of claim 16, wherein the keypad and the display are light emitting alternatively.

19. The system of claim 16, wherein the handset further comprises a leg that permits the handset to be self-standing.

20. The system of claim 16, wherein the keypad and the display are each powered by an independent power source.

21. The system of claim 16, further comprising a remote control that controls the display, the handset, the functions of the handset or combinations thereof.

22. The system of claim 16, wherein the handset is a speakerphone.

23. The system of claim 16, wherein the display is visible to a person with ordinary vision from at least about twenty, twenty-five, thirty, forty-five or even sixty feet.

24. The system of claim 16, wherein the display may be modified by the user to make it more visible for the visually-challenged.

25. A method for providing information in a single-unit comprising: displaying the information on a handset comprising a first and a second surface, a keypad, a speaker and a microphone, wherein the handset comprises at least about sixty percent of either the first or second surface of the telephone, wherein the display is visible to a person with ordinary vision from at least about fifteen feet.
